(19) United States
(12) Patent Application Publication
(10) Pub. No.: US 2012/0128441 A1
(43) Pub. Date: May 24, 2012

(54) Cargo restraint device

(76) Inventor: David M. McDaniel, Birmingham, AL (US)

(21) Appl. No.: 12/927,574

(22) Filed: Nov. 18, 2010

(51) Int. Cl. B60P 7/12

(52) U.S. Cl. 410/47

(57) ABSTRACT

A cargo restraint device that provides for multiple top-mounted restraint elements placed strategically around the top surface of a heavy metal coil for securing the metal coil to a surface of a transportation vehicle. The device includes a pair of elongated, heavy-duty restraint belts that are adapted to be placed length-wise over the top of the heavy metal coil and along each edge of the heavy metal coil and spaced-apart from each other, each belt having a first inner surface and a second outer surface and further having (optional) integral tabs extending outwardly from the respective edges of the heavy-duty restraint belt and being spaced at a pre-determined distance along the major axis of belt. A plurality of angle irons are adapted to be rigidly mounted to the outer surface of each belt transverse to the major axis of each belt in registry with the tabs. A plurality of flat metal bars are adapted to be rigidly mounted to the inner surface of each belt transverse to the major axis of each belt in registry with integral tabs and the corresponding angle iron. Means are provided for rigidly mounting the angle irons and flat metal bars to each belt. Lastly, a plurality of restraint elements are provided for securing the metal coil to the surface of the transportation vehicle, each of the restraint elements being adapted to lie along and in registry with the back portion of each of the angle irons and in registry with each of the respective tabs whereby each restraint element is prevented from slipping around the coil's radius; and means for securing the restraint elements to the surface of the transportation vehicle.

### CROSS REFERENCE TO RELATED APPLICATIONS

Not Applicable

### BACKGROUND OF THE INVENTION

1. Field of Invention

The present invention relates to a cargo restraint device for securing heavy objects to a surface and more particularly to a cargo restraint device for securing heavy metal coils to the bed of a transportation vehicle, such as a tractor trailer or flat railroad car, for safe transportation.

2. Description of the Related Art

In the transportation industry a particular problem has been encountered with the transportation of heavy objects, such as heavy steel coils. Typically, these steel coils are manufactured in widths of 48″, 54″, and 62″ and weigh anywhere from 15,000 pounds to 48,000 pounds. These heavy coils are typically secured with multiple tie-downs (e.g., chains) as a single coil in the middle of the trailer bed with its major axis along the major axis of the trailer bed. As such, the metal coil can shift during transient and in some cases due to the large kinetic energy generated during emergency braking have broken loose from the tie-down restraints and fallen off the trailer bed, creating a hazaderous situation to surrounding vehicles and people. Further, these metal coils are being presently bound with 5 to 6 chains, typically through the center opening of the coil near the bottom which causes the coil to be top-heavy and because the chains are short and at the bottom, there is little leverage to speak of.

Heretofore, numerous cargo restraint systems have been devised to secure heavy objects such as steel coils to the surface of a flat bed trailer. For example, one apparatus for securing large objects, such as heavy steel coils, to a tractor trailer is described in U.S. Pat. No. 5,538,376 and includes a pair of brackets with each of the brackets having an elongated member with a pair of pivotally mounted cleats attached at opposing ends of the elongated member. In operation the brackets are seated on the top of the steel coil on substantially opposing sides of the steel coil with each of the cleats pivoting to adjust to the contour of the coil. Each of the cleats has a first U-shaped passage or channel for receipt of restraining chains which are then secured to the bed of the tractor trailer.

While the patent claims a securing device that is adequate for securing steel coils to a flat bed truck that will not, even when the truck overturns, be separated from its securing device, it is believed that such a securing device which is limited by its design to a single set of restraint chains per side will not be adequate for securing larger steel coils (e.g., 62 inches wide and weighing upwards of 48,000 pounds) which are common in the manufacturing sector. Currently DOT has not approved top-mounted only coil restraint devices and it is highly doubtful that this top-mounted securing device would be approved with its limitation to a single set of chains per side. Moreover, it is noted that such securing devices will require that the brackets come in different lengths to accommodate different size coil diameters, which makes the securing device more expensive and cumbersome to use.

U.S. Pat. No. 2,772,064 provides a hinge guard load protector for use in binding loads upon trucks, railway cars and the like. The hinge guard load protector comprises two similar metal members having a flat lower surface for contact with the load, such as a steel coil, a convex upper surface for contact with flexible binding member (e.g., a chain), and a guide for receiving the flexible binding member. The members are hinged together so that the load protector may be located at any desired point upon the flexible binding member and when deployed with a second similar set of hinged members may be positioned on either side of the coil. This load protector which mounts the flexible binding member around the circumference of the coil suffers in that the device will not prevent swaying of the coil when going around curves and possible overturn of the coil with separation from the truck bed.

Another cargo restraint device is described in U.S. Pat. No. 4,526,500. There a protective member (block) for use in securing metal coils to a transport vehicle is provided comprising a formed, hard, wear-resistant material having a coil contacting surface and an opposed surface which is grooved to receive secure member, such as a chain. A plurality of magnetic strips is secured to the coil for positioning the block on the metal coil. While this device provides may solve the problem of protecting the coil from damage from the restraint chain, it is made of a plastic material which will wear down after repeated use and requires strips of a magnetic material for positioning the device on the coil.

Additional designs have addressed the protection of the edge of the metal coil during transportation. For example, U.S. Pat. No. 6,183,840 discloses a protector strip for protecting the edge of a coil. It employs an extruded plastic strip that has a curved surface with a longitudinal groove, a flexible covering portion which extends from one side of the longitudinal groove and which is adapted to be placed over and conform with the curved surface of the coil, and a plurality of tabs hinged to and extending from the other side of the longitudinal groove. The flexible covering portion has a plurality of holes, as does the tabs. Being constructed of plastic, makes the edge protector less rugged and it provides no features for accommodating restraint elements, such as heavy duty chains.

A further device for protecting metal coils is shown in U.S. Pat. No. 5,861,204. There a molded shield, which is made from ultra-high molecular weight, high density polyethylene, comprises a section to be inserted into the end of the coil or core. This section has a degree of curvature approximating that of an inside surface of the coil. A second section integral to the first section and substantially perpendicular to the first section abuts the end of the coil into which the first section is inserted. This protective shield is made of molded polyethylene and is not of a rugged design.

While these prior art cargo restraint devices may fulfill their respective particular objectives, they do not provide a device that provides for strategic locations across the top of heavy metal coils of restraint elements, creating a more even distribution of the load while providing for multiple restraint elements, e.g., up to five (5) elements, while protecting the heavy metal coil. Moreover, the prior art edge protector strips or partial shields leave much to be desired in providing long-term rugged and heavy duty coil protectors.

Thus, it may be seen that there is a need to provide a simple and effective cargo restraint device that can safely secures heavy metal coil to a transportation surface, for transportation across highways and railway, while protecting the metal coil from damage during shipment. There also is a need to provide a cargo restraint device that provides for top-mounted restraint elements for heavy metal coils that meets or exceeds DOT requirements for transporting metal coils.

### BRIEF SUMMARY OF THE INVENTION

In view of the above needs, it is a primary objective of the present invention to provide a simple, efficient and rugged cargo restraint device for securing heavy metal coils to the surface of a transportation vehicle, while protecting the heavy metal coil from damage during shipment.

Another objective of the invention is to provide a cargo restraint device for heavy metal coils that provides for the strategic positioning of multiple restraint elements around the top portion of heavy metal coils, creating a more even distribution of securing the load.

A further object of the invention is to provide a cargo restraint device that provides for multiple top-mounted restraint elements that substantially increases the holding capacity of the restraint device, providing for spreading and leveraging advantages over other restraint devices.

Other and further objects of the present invention will become apparent to those skilled in the art from a reading of the following detailed description of the invention together with the appended claims and by reference to the accompanying drawings.

The present invention addresses these needs by providing a cargo restraint device that provides for multiple top-mounted restraint elements placed strategically around the top surface of a heavy metal coil for securing the coil to a surface of a transportation vehicle. The invention significantly increases the holding capacity (in some cases a doubling of the holding capacity) of the cargo restraint device and provides for a more even distribution of the load without the attendant problem of having the multiple restraint elements slipping around the coil's radius. The invention also provides a cargo restraint device that minimizes or eliminates damage to the heavy metal coil during shipment, which reduces cost of operation. Upon delivery of the metal coil to its final destination, the cargo restraint device may be easily rolled into a small roll, approximately the size of a rolled-up tarp, for storage until the next pickup or shipment. Beneficially, the cargo restraint device of the current invention—though rugged in design and construction—weighs less than 60 pounds which can easily be handled by the driver of the tractor trailer.

In accordance with the present invention, there is provided a cargo restraint device for use in securing a heavy metal coil to a surface of a transportation vehicle 1, such as a tractor trailer, for safe transportation. The cargo restraint device broadly includes at least two elongated, heavy-duty restraint belts 3 that are adapted to be placed length-wise over the top of the heavy metal coil 2 and along each edge of the heavy metal coil 2 and spaced-apart from each other. Each belt 3 has a first inner surface and a second outer surface. Optionally, each belt may be provided with-integral tabs 4 that extend outwardly from the respective edges of each belt 3 and being spaced at a pre-determined distance along the major axis of each belt 3, the tabs 4 being adaptable to bend along an edge of coil 2. A plurality of angle irons 5 are adapted to be disposed on and rigidly mounted to the outer surface of each belt 3 transverse (preferably, at substantially a right angle thereto) to the major axis of each of the belts 3 in registry with tabs 4. Each of the respective angle irons is preferably sized to be of a length substantially coextensive with the width of each belt. A plurality of flat metal bars 6 are adapted to be rigidly mounted to the inner surface of each belt 3 transverse (preferably at substantially a right angle thereto) to the major axis of each of the belts 3 in registry with integral tabs 4 and said corresponding angle iron 5. Preferably, each of the respective flat metal bars is similarly sized to be of a length substantially coextensive with the width of each belt. Means are provided for rigidly mounting each of the respective angle irons 5 and corresponding each of flat metal bars 6 to each of the belts 3. Lastly, a plurality of restraint elements 7 are provided for securing metal coil 2 to the surface of the transportation vehicle 1, each of the restraint elements 7 being adapted to lie along and in registry with the back portion of each of the respective angle irons 5 and in registry with each of the respective tabs 6 whereby each restraint element 7 is prevented from slipping around the coil's radius; and means for securing the restraint elements 7 to the surface of the transportation vehicle 1.

The present invention provides for a number of advantages over the prior art devices. First, the restraint belts 3 of the present invention permit the restraint elements 7, e.g., heavy duty chains, to be placed in strategic locations across the top of the coil 2 for even distribution and maximum load distribution of the coil 2. Beneficially, the present invention provides, in some cases, for a doubling of the holding capacity of the cargo restraint device. Further, each angle iron 5 serves as a holding device so that the restraint elements 7 may be placed across the top portion of the coil 2 without slipping around the coil's radius. Additionally, the restraint belt 3 is sandwiched between the flat metal bar 6 and a respective angle iron 5 and secured with bolts and nuts and in this way the flat metal bar 6 serves as a metal washer the same size as the angle iron 5 to prevent pulling through or bursting of the restraint belt 3.

Second, the cargo restraint device of the present invention is a simple and straightforward design for safely securing a heavy coil, such as a heavy metal coil, to a bed of a transportation vehicle.

Additionally, as may be seen from the drawings and detailed description of the invention, the cargo restraint device is rugged in design but is light weight, weighing less than 60 pounds which can easily be handled by the driver of the tractor trailer.

### BRIEF DESCRIPTION OF THE SEVERAL VIEWS OF THE DRAWINGS

FIG. 1 is a side perspective view of the present invention that depicts the cargo restraint device in a preferred embodiment having at least two elongated, heavy-duty restraint belts 3 spaced-apart from each other and positioned over the top of a heavy metal coil 2 and along the respective edges of coil 2 having three (3) chains 7 placed at a pre-determined distance along the length of the respective restraint belts 3 with each chain 7 being held in position by one of four (4) angle irons 5 (a set of two angle irons 5 are mounted at the 12 o'clock position) that are rigidly affixed to the respective restraint belts 3 for even distribution of the load for securing the coil 2 to the tractor trailer bed 1.

FIG. 2 is a side perspective view of the present invention that shows the preferred placement of the angle irons 5 rigidly affixed to two restraint belts 3 at strategic positions on restraint belts 3. In the preferred embodiment angle irons 5 are located in three (3) positions for positioning of the three (3) restraint elements at 10:30 o'clock, 12 and 1:30 on restraint belt 3. Optionally, two additional angle irons 5 are shown at the nine o'clock and 3 o'clock but are not required for the practice of the present invention.

FIG. 3 is an end perspective view that illustrates for the present invention the spacing of two of cargo restraint belts 3 with respect to the width of a typical metal coil 2.

FIG. 4 is a top plan view of one of the restraint belts 3 of the present invention showing the preferred embodiment of angle irons 5 in spaced relationship to each other along the major axis of restraint belts 3 and further showing the top angle irons 5 as a pair of opposing angle irons 5 to thereby form a channel in which the top restraint element is placed.

FIG. 5 is a side perspective view of the present invention showing the positions of a top and side of two restraint elements 7 in relationship to being positioned along the back side of respective angle irons 5.

FIG. 6 is a side plan view of the present invention showing the arrangement of the restraint belt 3 sandwiched between four spaced-apart angle irons 5 and associated flat metal bars 6 rigidly secured with bolts 8 and nuts 9.

### DETAILED DESCRIPTION OF THE PREFERRED EMBODIMENTS

The preferred embodiments illustrated are not intended to be exhaustive or to limit the invention to the precise forms disclosed. They are chosen and described to explain the principles of the invention and it practical use and to thereby enable others skilled in the art to utilize the invention. The present invention can best be described with reference to the attached drawings. The reference characters refer to the same parts throughout the various views. The drawings are not to scale and are presented to help illustrate the principles of the present invention in a clear manner. While the invention may be utilized with different transportation vehicles, such as a tractor trailer or flat-bed rail cars, it will be illustrated in connection with a cargo restraint device for use with securing a heavy metal coil to a tractor trailer.

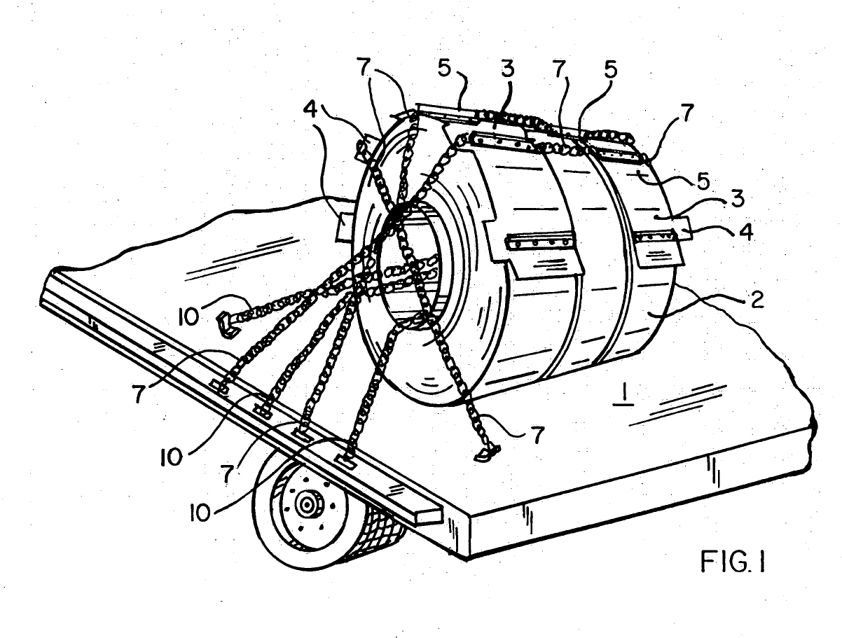

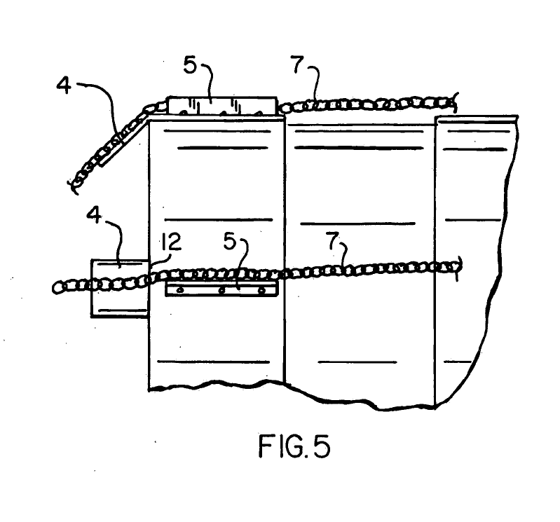

In one embodiment of the present invention as shown in FIG. 1 and FIG. 6, there is provided a cargo restraint device for use in securing a heavy metal coil 2 to a surface of a tractor trailer 1 for safe transportation. The cargo restraint device broadly includes at least two elongated, heavy-duty restraint belts 3 that are adapted to be placed length-wise over the top of the heavy metal coil 2 and along each edge of the heavy metal coil 2 and spaced-apart from each other. Each belt 3 has a first inner surface and a second outer surface. Optionally, each belt 3 may be provided with integral tabs 4 that extend outwardly from the respective edges of belt 3 and being spaced at a pre-determined distance along the major axis of each belt 3, the tabs 4 being adaptable to bend along an edge of coil 2 when engaged by restraint elements 7. A plurality of angle irons 5 are adapted to be rigidly mounted to the outer surface of each belt 3 transverse (preferably, at substantial a right angle thereto) to the major axis of each of the belt 3 in registry with tabs 4. Each of the respective angle irons is preferably sized to be of a length substantially coextensive with the width of each belt. A plurality of flat metal bars 6 are adapted to be rigidly mounted to the inner surface of each belt 3 transverse (preferably, at substantial a right angle thereto) to the major axis of each of the belts 3 in registry with integral tabs 4 and said corresponding angle iron 5. Preferably, each of the respective flat metal bars is similarly sized to be of a length substantially coextensive with the width of each belt. Means are provided for rigidly mounting each of the respective angle irons 5 and corresponding each of flat metal bars 6 to each of the belts 3. Lastly, a plurality of restraint elements 7 are provided for securing metal coil 2 to the surface of the tractor trailer 1, each of the restraint elements 7 being adapted to lie along and in registry with the back portion of each of the respective angle irons 5 and in registry with each of the respective tabs 4 whereby each restraint element 7 is prevented from slipping around the coil's radius; and means for securing the restraint elements 7 to the surface of the tractor trailer 1. Not shown are DOT-required chocks which are placed on the surface of tractor trailer 1 and in direct contact with metal coil 2 for securing metal coil 2 from forward and backward motion during transportation. These may be of any conventional components (wood or metal), such as chocks, wedges, a cradle or other equivalent means to prevent rolling.

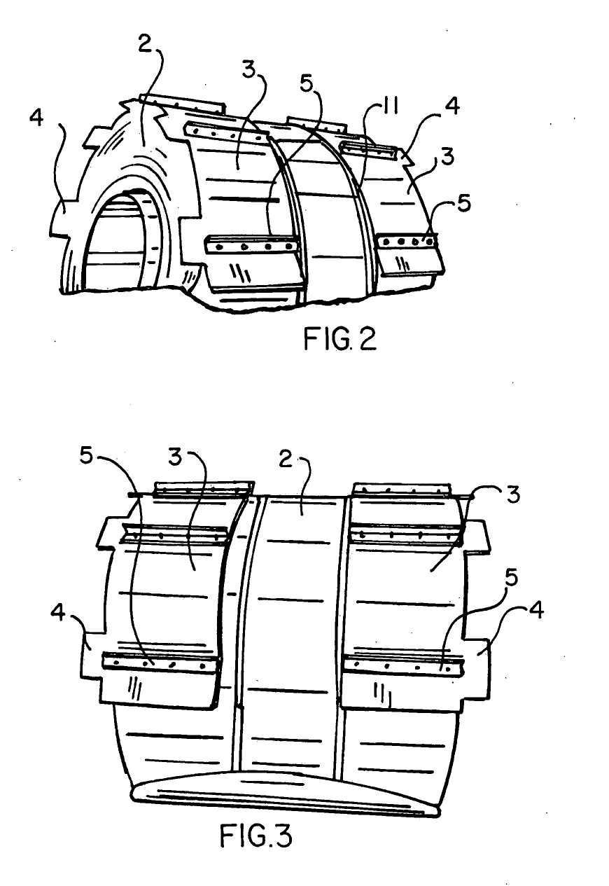

Optionally, two additional angle irons 5 may be mounted, as shown in FIGS. 2 and 3, on the each pair of cargo restraint belts 3 for the placement of two additional restraint elements 7 for additional support and to further spread the load across the restraint elements 7. Further, additional restraint elements 10, e.g., three, may, as shown in FIG. 1, be placed through the core of metal coil 2 to provide additional support for securing coil 2 to the surface of the tractor trailer 1. The use of these lower restraint elements 10 are not necessary for safely securing the coil 2 to the surface of the tractor trailer 1 when using the cargo restraint device of the present invention but are illustrated because they currently are required by DOT Sec. 393.100(c) Coils.

The restraint belts 3 may be made of any heavy duty material that has sufficient burst strength. A suitable material for the restraint belts 3 is a 4-440 conveyor belt (4-ply and 440 lbs./in width; having a tensile strength for 16 inch width belt of about 7040 lbs./in²) which is commercially available from the Fenner-Dunlop Americas company of Scottdale, Ga. 30079. In accordance with the present invention, the restraint belts 3 should be of a length that is selected with reference to the outside diameter of the steel coil 2. In general the overall length should be selected such that the ends of the belt 3 will not extend to the center line of the coil 2. Preferably each of the restraint belts 3 are positioned on the steel coil 2 such that the center of the restraint belts 3 is at the top of the steel coil 2 (i.e., at the noon or 12 o'clock position) and each side of the restraint belts 3 extends equally around the curvature of the steel coil 2 past the 10:30 and 1:30 o'clock positions. Typically steel coils come in varying diameters ranging from 36″ to 72.″ For a 72 inch diameter steel coil 2, a restraint belt 3 having an overall length of 62 inches and 16 inches in width is quite suitable. In the preferred embodiment of the present invention having three restraint elements 7, a pre-determined distance between each of the tabs may be: 5 inches, 10 inches, 10 inches and 5 inches with the tab lengths being 10 inches, 12 inches and 10 inches, totaling 62 inches. Each tab 4 is approximately 4 inches in width.

In a preferred embodiment of the present invention each of the respective restraint belts 3 has at least four angle irons 5 spaced-in a pre-determined distance along its major axis, with two being placed at the top of the coil 2 when the restraint belt 3 is draped over the coil to provide a channel in which the top restraint element 7 is placed to prevent slippage of the restraint element 7 to either side of the coil's radius. It should also be noted that the other two angle irons 5 are to be oriented facing in the same direction of the respective top angle irons 5 so that each restraint element 7 may be placed across the back of the angle iron 5 which serves as a holding device to prevent slippage of the restraint element 7 around the coil's radius. Angle irons 5 may be made of conventional materials of construction, such as mild steel, and preferably may be provided in a size of a 2×2×¼ inch angle iron. The flat metal bar 6 similarly may be made of conventional materials of construction, such as mild steel and preferably may be provided in a size of 2×¼ inch metal bar. In this way the flat metal bar 6 serves as a metal washer the same size as the angle iron 5 to prevent pulling through or bursting of the restraint belt 3.

FIG. 2 is a side perspective view that shows the preferred placement of the angle irons 5 rigidly affixed to restraint belts 3 at strategic positions, namely at 10:30, 12 o'clock (noon) and 1:30, on restraint belts 3. With this placement of the angle irons 5, the angle of the restraining elements 7 with tabs 4 is at an optimum angle of about 30 degrees for maximum leverage of the restraining elements 7 on metal coil 3. Moreover, such a placement provides for a more even distribution of the load of steel coil 2 on tractor trailer 1. In addition to the preferred embodiment of three angle irons 5 shown, two additional angle irons 5 may be used in the practice of the present invention and are shown mounted on the respective restraint belts 3 at about the 3 o'clock and 9 o'clock positions for the placement of two additional restraint elements 7. The use of five (5) restraint elements provides for additional support of metal coil 2 and further spreads the load across the restraint elements 7.

Also shown in FIG. 2 is a coil protective blanket 11 which is first draped over steel coil 2 before the respective restraint belts 3 are placed over the steel coil 2. The purpose of blanket 11 is to provide a protective layer between the outer surface of steel coil 2 and the heads of bolts 8 (as shown in FIG. 6) used to rigidly affix flat metal bars 6 to the inner surface of the restraint belt 3 and corresponding angle iron 5 with nut 9. Blanket 11 may be made of any suitable durable material; it is preferably made of a 2 ply 220 conveyer belt (220 lbs./inch width) and may be about ¼ inch thick, available from the Fenner-Dunlop Americas company of Scottdale, Ga. 30079. The blanket 11 may be of a width slightly wider than the restraint belts 3 and multiple blankets 11 may be provided, one underlying each of the respective restraint belts 3. This blanket provides both a protective layer for the metal coil 2 and a non-skid surface between the metal coil 2 and the metal bolt heads.

FIG. 3 is an end perspective view of the present invention that illustrates the spacing of the pair of restraint belts 3 with respect to the width of a typical metal coil 2. Typically, heavy steel coils 2 come in varying widths of 48, 54 and 62.″ As noted before, a width of 16 inches is suitable for each of the restraint belts 3. Accordingly, for a 62 inch wide steel coil 2 with the placement of at least two restraint belts 3 on steel coil 2 there will be approximately 30 inches space between belts 3. It will be obvious that the spacing between the pair of restraint belts 3 will vary for each width of coil 2. In this figure, an additional angle iron 5 is shown mounded just above the end of each pair of restraint belts 3 at approximately the 3 o'clock position for the placement of an additional restraint element 7. A corresponding angle iron 5 is mounted (hidden) just above the opposite ends of cargo restraint belt 3 at approximately the 9 o'clock position. As noted above, the addition of these two restraint elements 7 provides for additional support of metal coil 2 and further spreads the load across the restraint elements 7.

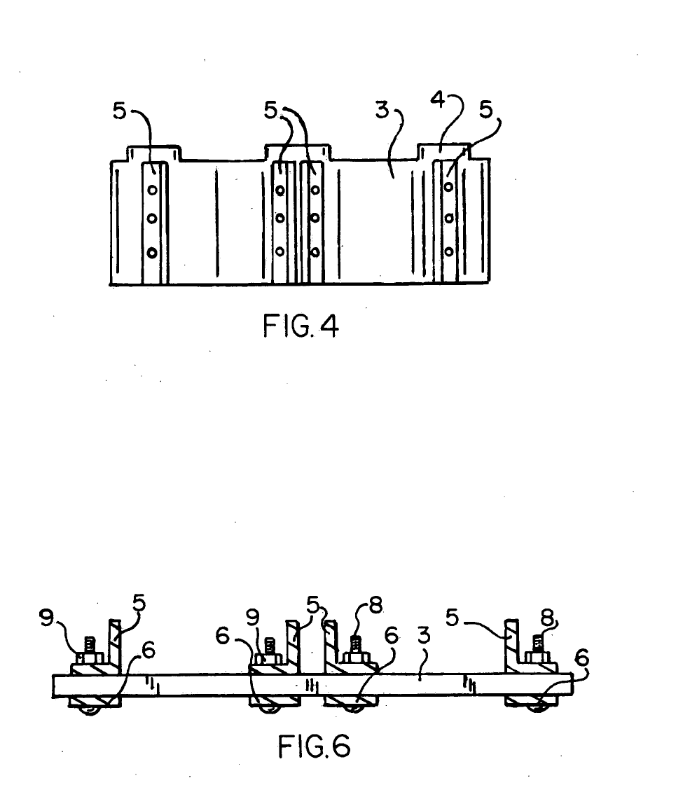

Referring to FIG. 4, angle irons 5 are shown in spaced relationship to each other along the major axis of restraint belt 3 with the top angle irons 5 being depicted as a pair of opposing angle irons 5 to thereby form a channel in which the top restraint element 7 is placed.

FIG. 5 is a side perspective view showing the positions of a top and side of two restraint elements 7 in relationship to being positioned along the back side of respective angle irons 5. Shown also are integral tabs 4 and the angle formed between the restraint elements 7 and tabs 6. Shown also is slit 12 in each of tabs 4 which is made on the top side of tab 4 and along the edge of restraint belt 3. The purpose of slit 12, which may be about ¼ of an inch deep, is to facilitate the bending of tabs 6 when the restraint elements are secured to the bed of tractor trailer 1.

FIG. 6 is a side plan view of the present invention showing the arrangement of the restraint belt 3 sandwiched between four spaced-apart angle irons 5 and associated flat metal bars 6 rigidly secured with bolts 8 (½×2 inches Grade 8 bolt which meets DOT specification) and nuts 9.

In operation, the metal coil 2 is loaded on the bed of tractor trailer 1 and for a 62 inch wide metal coil is placed in the middle of the bed of tractor trailer 1, secured with chocks to prevent forward or backward movement. Next, the coil protector blankets 11 are draped over the top surface of metal coil 2, insuring that each one aligns with the respective edges of metal coil 2 and extends inwardly from each edge sufficient to cover the restraint belts 3 which are then draped over the coil protector blankets 11. Again, care must be exercised in insuring that each restraint belt 3 aligns substantially with the respective edge of metal coil 2 and is placed in position on the top of metal coil 2 in such a manner that the center set of angle irons 5 are at the 12 o'clock position. Next, the end of restraint element 7 for the top restraint element 7 is secured through spaced-apart slots on the side of the tractor trailer 1 and laid in the channel formed by the pair of top angle irons 5, at the top of cargo restraint belt 3, engaging the respective tabs 4 and extending to a corresponding spaced-apart slot (not shown) on the opposite side of the bed of tractor trailer 1 and tightly secured thereto. In like manner the other two restraint elements are secured to spaced-apart slots and placed across the back side of their respective angle irons 5 engaging tabs 4 and secured to spaced-apart slots to complete the loading and securing of metal coil 1 to tractor trailer 1. Finally, the ends of the three lower restraint elements 10 are secured through spaced-apart slots and/or cleats provided in the trailer bed of tractor trailer 1 and passed through the core of coil 2 and extended to a corresponding spaced-apart slot and corresponding cleat(s) on the opposite side of the bed of tractor trailer 1 and tightly secured thereto.

The requirement for securing devices for transportation vehicles is set forth in the Federal Motor Carrier Safety Administration's web site at www.fmcsa.dot.gov/rules-regulations/truck/vehicle/cs-policy.htm which are hereby incorporated by reference. There, the regulations set forth that all the devices and systems used to secure cargo to or within a vehicle must be capable of meeting the performance requirements. Specifically, there is provided that the aggregate working load limit of any securement system used to secure an article against movement must be at least one-half the weight of the article. The aggregate working load limit is the sum of: one-half the working load limit of each tie-down that goes from an anchor point on the vehicle to an attachment point on an article of cargo; and the working load limit for tie-down that goes from an anchor point on the vehicle, through, over or around the cargo and attaches to another anchor point on the vehicle.

By way of illustration the following calculation of working load limits for a 62 inch wide steel coil weighing 48,000 pounds (19,600# per restraint element or tie-down per DOT requirements) is given for the preferred embodiment of the invention using three (3) restraint elements positioned at 12 o'clock, 10:30 and 1:30 on two restraint belts (each 440 # per inch wide) using (3) each ½×2 inches Grade 8 bolt, washers and nuts and 2 inch flat metal bar and angle iron:

Cargo restraint device of present invention:

(440×2)×(16×2)=880×32=28,160#(tensile strength of 2 belts).

½ inch×2 inches Grade 8 bolt:

23,400# each×3 per belt×2 belts=23,400×3×2=140,400#(tensile strength of bolts.

As may be seen for a cargo restraint device having 3 restraint elements in accordance with the present invention, the tensile strength (28,160×3 or 84,480 #) for the device exceeds the aggregate working limit of the metal coil (19,600×3 or 58,800 #) and for a cargo restraint device having 5 restraint elements in accordance with the present invention the tensile strength (28,160×5 or 140,800 #) for the device exceeds the aggregate working limit of the metal coil (19,600×5=98,000 #) the weight of the metal coil.

The cargo restraint device of the present invention was tested using a Field Simulator test rig that was constructed to simulate the action of a heavy steel coil loaded on a tractor trailer flat bed when braking in an emergency stop and to record the pressure at which the restraint elements (i.e., heavy-duty chains) break. The Field Simulator included a pair of pistons mounted independent of the trailer bed in a rearward position in relationship to the steel coil. In this configuration the pistons simulated the forward motion of the steel coil during a braking of the truck in an emergency stop. A steel coil which simulates a steel coil weighing approximately 25,000 pounds was placed on the test trailer bed in front of the pistons and secured to the test trailer bed by either passing the chains through the eye of the steel coil (prior art or conventional method) or over the top of the steel coil (in the positions of 10:30, 12 and 1:30 in accordance with the preferred embodiment of the present invention) and attached to cleats placed on the surface of the test trailer bed. The extractor part of each of the pistons was connected to the lifting eyes and the lifting eyes were welded to the curved surface of the steel coil. When activated, the pair of pistons moved upward and forward against the curved side of the steel coil during the test to simulate the motion and forward movement of the steel coil during an emergency stop. A pressure gauge was attached to the pistons for recording the pressure (#) at which the first and subsequent chains broke during the braking tests. Conventional chocks were placed in front of and behind the steel coil. In all of the field simulation tests identical heavy-duty chains were used.

First, a simulation test was run using three heavy-duty chains positioned through the eye of the coil and attached to cleats placed on the surface of the test trailer bed to rigidly attach the steel coil to the trailer bed. This configuration is the conventional configuration of coil restraints for heavy-duty metal coils that are currently approved by DOT for coils weighing up to 25,000 pounds. The pistons were actuated and the test run until the chain(s) broke. The pressure at which the first chain (back most chain) broke was recorded as 500 pounds with the forward movement of the steel coil being found to be 1⅝ inches and the piston movement being recorded as 3¼ inches. The pounds of force necessary to break the first chain were calculated to be to 28,270 pounds of force (Hydraulic Cylinder Force). The formula for calculating the Hydraulic Cylinder Force for the simulation test run was:

Piston Area (in²)×No. Pistons×Pressure (PSI)=Hydraulic Cylinder Force

Piston Area=6 inch diameter=28.2744 in²

Hydraulic Cylinder Force=28.274×500×2=28,274#

The chain along the center line of the steel coil was observed to hold. With the forward movement of the steel coil, the forward most chain went slack, contributing nothing to the restraining force holding the movement of the steel coil. This observation was quite unexpected and led to the conclusion that it was not the number of chains, which had been assumed to provide equal restraining force on the steel coil, but the position of the chains.

Next, a simulation test was run using six heavy-duty chains positioned through the eye of the steel coil, which simulated a steel coil weighing up to 50,000 pounds, and was secured to cleats attached to the surface of the test trailer bed to rigidly attach the steel coil to the trailer bed. This configuration is a conventional configuration of coil restraints currently approved by DOT for heavy-duty metal coils weighing up to 50,000 pounds. This simulation test run had as its object the breaking of two chains, recording the force required to break both chains, and recording the movement after the second chain broke. The pistons were actuated and the test run until the second chain broke. The pressure at which the first chain (back most chain) broke was recorded as 100 pounds and the second chain broke at 500 pounds with the forward movement of the steel coil being found to be 2½ inches and the piston movement being recorded as 6⅛ inches. It was observed that the pressure required to break chains in this simulation test run using six chains was no different than the pressure required to break three chains. Using the calculation for the first simulation test, the pounds of force necessary to break the first chain was calculated to be 5,654 pounds of force and for the second chain was 28,270 pounds of force. The chains along the center line of the steel coil were observed to be holding at this point. The two back most chains broke first; it was observed that the back most chain(s) always broke first. This was due to the fulcrum or pivot point of the steel coil being transferred onto the front chock. With the forward movement of the steel coil, the forward most chains went slack, contributing nothing to the restraining force holding the movement of the steel coil. This observation was the same for the test with the three chain simulation test run, confirming that it was the position of the chains and not the number of the chains that determines the maximum restraining force to secure the steel coil in an emergency braking situation.

Next, a simulation test was run using the preferred embodiment of the present invention; namely, with three heavy-duty chains 7 placed on the top of a steel coil 2 at noon and at 10:30 and 1:30 on the restraint belts 3 and attached to cleats to rigidly attach the steel coil to the trailer bed. The pistons were actuated and the test run until the first chain broke. This compares to the simulation test run using three chains through the eye of the steel coil. The pressure at which the first chain broke was recorded as 550 pounds and the forward movement of the steel coil being found to be 2 15/16 inches and the piston movement being recorded as 7 inches. Using the calculation for the first simulation test run, the pounds of force necessary to break the chain were calculated to be to 31,097 pounds. It may be seen that the cargo restraint device of the present invention beneficially provided 10% greater restraining force with the chains being applied to the top of the coil when compared to the currently DOT approved chains through the eye of the steel coil. This demonstrated the effectiveness of the present invention against the forward movement of the steel coil than either of the restraint system currently approved by DOT for transport of heavy steel coils.

Next, a simulation test was run using the preferred embodiment of the present invention with three heavy-duty chains on the outside of the steel coil as above and with three heavy-duty chains through the eye of the steel coil. This simulation test run had as its object the breaking of two chains, recording the force required to break both chains, and recording the movement after the second chain broke. The pistons were actuated and the test run until the second chain broke. This compares to the simulation test run using six chains through the eye of the steel coil where two chains broke. The pressure at which the first chain broke was recorded as 700 pounds and the second chain broke at 600 pounds, with the forward movement of the steel coil being found to be 3¼ inches and the piston movement being recorded as 7¾ inches. Using the calculation for the first simulation test, the pounds of force necessary to break the first chain were calculated to be to 39,924 pounds and the pounds of force necessary to break the second chain were calculated to be to 33,924 pounds. It may be seen that the cargo restraint device of the present invention provided 85% greater restraining force on the first chain (as measured during the simulation test run with conventional six chains through the eye of the steel coil) against the forward movement of the steel coil than either of the restraint system currently approved by DOT for transport of heavy steel coils. Accordingly, it may be seen that the cargo restraint device of the present invention provides the safest way for securing and transporting heavy metal coils on the U.S. highways.

It is to be understood that the invention is not limited to the details give as described above but that it may be modified within the scope of the appended claims.

Having thus described the aforementioned invention, we claim:

1. A cargo restraint device for securing heavy metal coils to a surface of a transportation vehicle comprising:
a) at least two elongated, heavy-duty restraint belts adapted to be placed length-wise over the top of said metal coil and along each edge of said metal coil and spaced apart from each other, each one of said belts having a first outer surface and a second inner surface;
b) a plurality of angle irons, each of said angle irons being adapted to be disposed on and rigidly mounted to said outer surface of each of said elongated, heavy-duty belts transverse to the major axis of each of said elongated, heavy-duty belt and being spaced apart from each other;
c) a plurality of metal bars, each of said metal bars being adapted to be rigidly mounted to said inner surface of each of said elongated, heavy-duty belts transverse to the major axis of each of said elongated, heavy-duty belts and each of said metal bars being in registry with a corresponding angle iron;
d) means for rigidly mounting each of said angle irons and said metal bar to said elongated, heavy-duty belt;
e) a plurality of restraint elements for securing said metal coil to the surface of said transportation vehicle, each of said restraint elements being adapted to lie along and in registry with the back portion of each on the respective angle coil's radius; and
f) means for securing said restraint elements to the surface of said transportation vehicle.

2. The device as set forth in claim 1 wherein said angle iron comprise mild steel.

3. The device as set forth in claim 1 wherein said metal bar comprises mild steel.

4. The device as set forth in claim 1 wherein said elongated, heavy-duty restraint belt comprises a conveyor belt.

5. The device as set forth in claim 4 wherein said conveyor belt comprises a 4-ply belt having a width of approximately 16 inches and having a tensile strength of approximately 7040 lbs/in².

6. The device as set forth in claim 1 wherein said first outer surface of each of said elongated, heavy-duty restraint belt has a corresponding angle iron and said inner surface has a corresponding metal bar and said means for rigidly mounting said angle iron and said metal bar to said elongated, heavy-duty belt comprise a bolt and a nut.

7. The device as set forth in claim 1 wherein said elongated, heavy-duty restraint belt comprise two belts, each of which has at least three sets of rigidly mounted angle irons that are disposed substantially in the 10:30, 12 and 1:30 o'clock position.

8. The device as set forth in claim 7 wherein said set of angle irons at the 12 o'clock position further comprises a set of two angle irons, said angle irons being oriented facing in the same direction whereby a channel is provided for placement of the top restraint element.

9. The device as set forth in claim 1 wherein said at least two elongated, heavy-duty restraint belts each having an integral tab, said tab extending outwardly form the respective edges of each of said belts and being spaced at a pre-determined distance along the major axis of each of said belts and adapted to register with a corresponding restraint element for securing said metal coil to the surface of said transportation vehicle.

10. The device as set forth in claim 1 wherein said plurality of restraint elements comprise at least three heavy-duty chains, each of said heavy-duty chains being adapted to lie along and in registry with the back portion of each of a corresponding said angle iron.

11. The device as set forth in claim 10 further comprises at least three heavy-duty chains being positioned through the eye of said metal coil.

12. The device as set forth in claim 1 further comprises a coil protector blanket disposed between said metal coil and said at least two elongated, heavy duty restraint belts.

13. The device as set forth in claim 1 wherein said heavy metal coil comprises a steel coil.

14. The device as set forth in claim 13 wherein said steel coil weighs approximately 25,000 pounds.

15. The device as set forth in claim 13 wherein said steel coil weighs approximately 50,000 pounds.

16. The device as set forth in claim 10 wherein said device had a restraining force for forward movement of said metal coil in excess of 31,000 pounds.

17. The device as set forth in claim 16 wherein said device had a restraining force for forward movement of said metal coil of approximately 39,900 pounds.
